(19) United States
(12) Patent Application Publication
(10) Pub. No.: US 2025/0251579 A1
(43) Pub. Date: Aug. 7, 2025

(54) FAR-INFRARED OPTICAL SYSTEM AND OPTICAL CAMERA WITH WIDE ANGLE

(71) Applicant: SHENZHEN METALENX TECHNOLOGY CO.,LTD, Shenzhen (CN)

(72) Inventors: Chengliang LAI, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 19/034,475

(22) Filed: Jan. 22, 2025

(30) Foreign Application Priority Data
Feb. 6, 2024 (CN) 202420283645.X

(51) Int. Cl. G02B 13/00; G02B 1/00; G02B 13/04

(52) U.S. Cl. CPC G02B 13/008; G02B 1/002; G02B 13/003; G02B 13/04

(57) ABSTRACT

A far-infrared optical system and an optical camera with a wide angle are provided, the far-infrared optical system with the wide angle includes a metalens, an aperture slot, and an aspheric lens in order from an object side to an image side; each of the metalens and the aspheric lens has a positive focal power; each of the metalens and the aspheric lens includes an object-side surface facing towards the object side and an image-side surface facing towards the image side; the aperture slot is a ring structure set on the image-side surface of the metalens; the metalens includes a plurality of nanostructures, and a projection of the plurality of nanostructures in an effective region of the image-side surface of the metalens is located inside a ring region of the aperture slot.

### CROSS-REFERENCE TO RELATED APPLICATION

This application claims the benefit of priority from Chinese Patent Application No. 202420283645.X, filed on Feb. 6, 2024. The content of the aforementioned application, including any intervening amendments thereto, is incorporated herein by reference in its entirety.

### TECHNICAL FIELD

The present disclosure relates to a field of lens, in particular to a far-infrared optical system with a wide angle.

### BACKGROUND

A hybrid optical system of metalens and refractive lens refers to an optical system that includes a metalens and a refractive lens. For a far-infrared optical system with the wide angle, in the related technology, a two-piece far-infrared optical system designed based on the hybrid system of metalens and refractive lens is provided, so as to make the system with good imaging quality while satisfying the requirements of small volume and large field of view. However, the relative illumination of the two-piece far-infrared optical system provided by the relevant technology is not very ideal and needs to be further improved.

### SUMMARY OF INVENTION

One purpose of the present application is to provide a far-infrared optical system and an optical camera with a wide angle, and the relative illumination of the far-infrared optical system with the wide angle provided by the present application has been improved.

In the first aspect, a far-infrared optical system with a wide angle is provided, the far-infrared optical system includes a metalens, an aperture slot, and an aspheric lens in order from an object side to an image side;
wherein, each of the metalens and the aspheric lens has a positive focal power;
each of the metalens and the aspheric lens includes an object-side surface facing towards the object side and an image-side surface facing towards the image side;
the aperture slot is a ring structure set on the image-side surface of the metalens;
the metalens includes a plurality of nanostructures, and a projection of the plurality of nanostructures in an effective region of the image-side surface of the metalens is located inside a ring region of the aperture slot.

In one embodiment, the plurality of nanostructures are set on the image-side surface of the metalens.

In one embodiment, the plurality of nanostructures are set on both the image-side surface of the metalens and the object-side surface of the metalens.

In one embodiment, both the image-side surface and the object-side surface of the aspheric lens are even-order surfaces.

In one embodiment, a back focal length of the far-infrared optical system is greater than or equal to 2.96 mm, and is less than or equal to 3 mm.

In one embodiment, the far-infrared optical system with the wide angle satisfies the condition as follows:

$$2. mm < f < 2.1 mm$$

wherein f is an effective focal length of the far-infrared optical system with the wide angle.

In one embodiment, the far-infrared optical system with the wide angle satisfies the condition as follows:

$$0.825 < \frac{{D}_{m}}{{L}_{m}} < 1$$

wherein Dₘ is a maximum effective radius of the far-infrared optical system with the wide angle, L_{M} is a coaxial distance between the object-side surface of the metalens and the image-side surface of the aspheric lens.

In one embodiment, the far-infrared optical system with the wide angle satisfies the condition as follows:

$$2.25 < \frac{{D}_{2 m}}{{D}_{1 m}}$$

wherein D₁ₘ is an effective diameter of the metalens, and D₂ₘ is a maximum diameter of the aspheric surface.

In one embodiment, the far-infrared optical system with the wide angle satisfies the condition as follows:

$$2.25 < \frac{{D}_{2 m}}{{D}_{1 m}} < 3.00 .$$

In one embodiment, the far-infrared optical system with the wide angle satisfies the condition as follows:

$$1.1 < \frac{\vert {SG}_{2 m} \vert}{\vert {SG}_{1 m} \vert} < 1.35$$

wherein SG₁ₘ is a sagittal maximum height of the object-side surface of the aspheric lens; SG₂ₘ is a sagittal maximum height of the image-side surface of the aspheric lens.

In one embodiment, a thickness of the aspheric lens is greater than or equal to 3.139 mm, and is less than or equal to 3.28 mm.

In one embodiment, a total track length of the far-infrared optical system with the wide angle is less than or equal to 7.1 mm.

In one embodiment, a field of view of the far-infrared optical system with the wide angle is greater than or equal to 117°.

In one embodiment, an F number of the far-infrared optical system with the wide angle is 1.

In one embodiment, a curvature radius of the object-side surface of the aspheric lens is greater than or equal to −7.52 mm, and is less than or equal to −7.063 mm.

In one embodiment, a curvature radius of the image-side surface of the aspheric lens is greater than or equal to −3.745 mm, and is less than or equal to −3.68 mm.

In the second aspect, a far-infrared optical camera with a wide angle is provided. The far-infrared optical camera with the wide angle includes a lens barrel and the far-infrared optical system with a wide angle;
an inner wall of the lens barrel is set with a first-stepped structure and a second-stepped structure;
the metalens is set on a platform of the first-stepped structure; and the aspheric lens is set on a platform of the second-stepped structure.

In one embodiment, the object-side surface of the metalens contacts the platform of the first-stepped structure, and the object-side surface of the aspheric lens contacts the platform of the second-stepped structure.

In one embodiment, the far-infrared optical camera with the wide angle further includes a pressure ring; the pressing ring contacts the image-side surface of the aspheric lens.

In one embodiment, the pressing ring contacts the inner wall of the lens barrel.

The far-infrared optical system includes a metalens, an aperture slot, and an aspheric lens in order from an object side to an image side; each of the metalens and the aspheric lens has a positive focal power; each of the metalens and the aspheric lens includes an object-side surface facing towards the object side and an image-side surface facing towards the image side; the aperture slot is a ring structure set on the image-side surface of the metalens; the metalens includes a plurality of nanostructures, and a projection of the plurality of nanostructures in an effective region of the image-side surface of the metalens is located inside a ring region of the aperture slot. Compared with the two-piece far-infrared optical system in the relevant technology, the far-infrared optical system with the wide angle further has been improved relative illumination.

Other features and advantages of the present application will become apparent by the detailed description below, or will be acquired in part by the practice of the present application.

It should be understood that the above general description and details are exemplary only, and do not limit this application.

### BRIEF DESCRIPTION OF DRAWINGS

The above and other targets, features and advantages of the example embodiment thereof by reference to the accompanying drawings.

FIG. 1 shows an optical architecture diagram of a far-infrared optical system with a wide angle provided in the present application.

FIG. 2 shows a schematic structure diagram of the wide-angle far-infrared optical lens provided in the present application.

FIG. 3 shows an optical architecture diagram of a far-infrared optical system with a wide angle provided by one embodiment of the present application.

FIG. 4 shows an MTF diagram of a far-infrared optical system with a wide angle provided by one embodiment of the present application.

FIG. 5 shows a relative illumination diagram of a far-infrared optical system with a wide angle provided by one embodiment of the present application.

FIG. 6 shows an optical architecture diagram of a far-infrared optical system with a wide angle provided by one embodiment of the present application.

FIG. 7 shows an MTF diagram of a far-infrared optical system with a wide angle provided by one embodiment of the present application.

FIG. 8 shows a relative illumination diagram of a far-infrared optical system with a wide angle provided by one embodiment of the present application.

FIG. 9 shows an optical architecture diagram of a far-infrared optical system with a wide angle provided by one embodiment of the present application.

FIG. 10 shows an MTF diagram of a far-infrared optical system with a wide angle provided by one embodiment of the present application.

FIG. 11 shows a relative illumination diagram of a far-infrared optical system with a wide angle provided by one embodiment of the present application.

FIG. 12 shows an optical architecture diagram of a far-infrared optical system with a wide angle provided by an embodiment of the present application.

FIG. 13 shows an MTF diagram of a far-infrared optical system with a wide angle provided by one embodiment of the present application.

FIG. 14 shows a relative illumination diagram of a far-infrared optical system with a wide angle provided by an embodiment of the present application.

### DETAILED DESCRIPTION OF THE EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio and size of the components are enlarged to clearly illustrate.

In addition, the described features, structures, or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, groups, etc. may be adopted. In other cases, aspects of the present application are blurred without a detailed showing or describing the public structure, method, implementation, or operation to avoid over-dominance.

The patent of CN220271648U in the related technology provides a two-piece far-infrared optical system based on a hybrid system of metalens and refractive lens. In detail, the patent of CN220271648U provides a two-piece far-infrared optical system, when the two-piece far-infrared optical system cooperates with the imaging sensor with a pixel size of 12 μm, the two-piece far-infrared optical system has good imaging quality. And the TTL (total track length) of the two-piece far-infrared optical system is less than 7 mm. And in the seven embodiments provided by the patent of CN220271648U, the maximum FOV (field of view) is 100°, 100°, 100°, 100°, 117.6°, 1140 and 117.6°, respectively.

Although the patent of CN220271648U provides a two-piece far-infrared optical system that has good imaging quality, and the far-infrared optical system satisfies small volume and larger field of view at the same time, and the RI (Relative Illumination) is not very ideal. The minimum RI (Relative Illumination) at full FOV is about 0.74, which can be further improved. Therefore, compared with the patent of CN220271648U, the RI of the far-infrared optical system with the wide angle provided by the present application has been further improved.

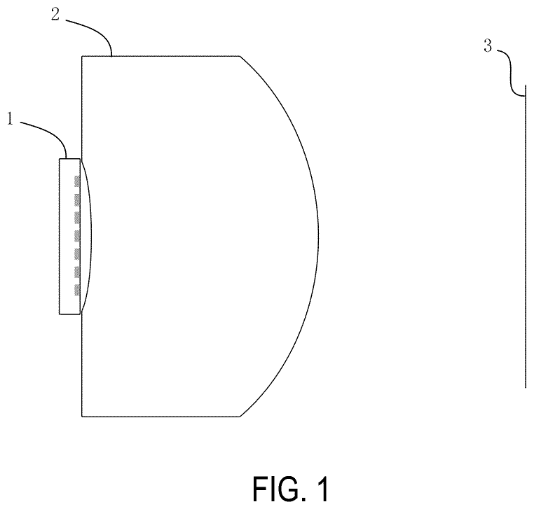

FIG. 1 shows an optical architecture diagram of the far-infrared optical system with the wide angle provided in the present application. As shown in FIG. 1, the far-infrared optical system with the wide angle includes a metalens 1, an aperture slot, and an aspheric lens 2 in order from an object side to an image side; and each of the metalens 1 and the aspheric lens 2 has a positive focal power.

The metalens 1 includes a plurality of unit cells set on the substrate, and the center/vertice of the unit cell is set with the nanostructures; the filler material may be air or other transparent materials at the working waveband.

Each of the metalens 1 and the aspheric lens 2 includes an object-side surface facing towards the object side and an image-side surface facing towards the image side.

In the present embodiment, the aspheric lens 2 is used to correct the low-order wavefront aberrations; and the metalens is used to correct the high-order wavefront aberrations and spherical aberrations at the edge field of view. Therefore, the metalens 1 and the aspheric lens 2 cooperate with each other, which will ensure that when the far-infrared optical system provided by the present application cooperates with the imaging sensor with a pixel size of 12 μm, the far-infrared optical system has good imaging quality and the maximum FOV at full FOV is controlled to be greater than 117°. Therefore, the far-infrared optical system with the wide angle includes only two lenses used to modulate lights, that is, the metalens 1 and the aspheric lens 2, and at the same time, the metalens 1 has a more thinner thickness compared with the traditional refractive lens. Therefore, the TTL (total track length) of the far-infrared optical system can be controlled to be less than 7.1 mm.

In the present embodiment, the aperture slot is used to control the light intake of the optical system and the width of incident lights for imaging. The aperture slot is a ring structure set on the image-side surface of the metalens 1 (for example, the aperture slot may be set on the image-side surface of the metalens 1 by coating the film, that is, in this situation, the aperture slot is a ring film). And a projection of the plurality of nanostructures in an effective region of the image-side surface of the metalens is located inside a ring region of the aperture slot. That is, when observing the effective region and the ring region on the object-side surface of the metalens 1, the effective region is located on the ring region. The effective region is a region where nanostructures are located, and the ring region is a region where the aperture slot is located. In this way, the blocking degree of the thickness of the aperture slot for the lights at the larger field of view can be reduced, which is beneficial to improve the relative illumination of the optical system. Specifically, for the far-infrared optical system with the wide angle provided in this application, the relative illumination at the full field of view can be controlled to be greater than 0.78. Compared with the two-piece far-infrared optical system of the patent of No. CN220271648U, the relative illumination of the far-infrared optical system with a wide angle has been increased by about 5%.

It should be noted that the nanostructures may be set on the object-side surface of the metalens 1, the nanostructures may be set on the object-side surface of the metalens 1, or the nanostructures may be set on the image-side surface of the metalens 1. And the filler material may be filled between the nanostructures, or there may be no filler material. When there is no filler material filled between the nanostructures, if the nanostructures are set on the object-side surface of the metalens 1 exposed outside, the nanostructures may be damaged by contacting the outside environment. Therefore, in one embodiment, preferably, the nanostructures are set on the image-side surface of the metalens 1, so as to improve the structural safety of the nanostructures.

In one embodiment, the nanostructures setting on one side of the metalens 1 may be one layer or may be multiple layers.

In one embodiment, the nanostructures may be set on the object-side surface of the metalens 1, or the nanostructures may be set on the image-side surface of the metalens 1. In one embodiment, the metalens 1 includes two structural surfaces, and the two structural surfaces are located at two sides of the metalens 1, that is, the nanostructures may be set on the object-side surface of the metalens 1, or the nanostructures may be set on the image-side surface of the metalens 1. That is, the metalens 1 is a double-sided metalens, which can be regarded as a combination of the two metalens using one substrate.

Compared with the one-sided metalens, the double-side metalens improves the design degree of freedom, which is beneficial to expand the maximum field of view and reduce the volume of the optical system.

Further, in one embodiment, the filler material is filled between the nanostructures on the object-side surface of the metalens to avoid the nanostructures on the object-side surface exposed outside, which can improve structural safety.

In one embodiment, both the object-side surface and image-side surface of the aspheric lens 2 are even-order aspheric surfaces.

In one embodiment, the even-order aspheric surface satisfies the formula as follows:

$$Z ( r ) = \frac{c {r}^{2}}{1 + \sqrt{1 - ( 1 + k ) {c}^{2} {r}^{2}}} + A {r}^{4} + B {r}^{6} + C {r}^{8} + D {r}^{10}$$

wherein r is a radius of any position of the aspheric surface in a radial direction, Z(r) is a vector height of the aspheric surface, c is a curvature of the aspheric surface, k is a conic coefficient, A is a four-order aspheric coefficient, B is a six-order aspheric coefficient, C is an eight-order aspheric coefficient, D is a ten-order aspheric coefficient.

Both the image-side and object-side surfaces of the aspherical lens 2 as even-order aspheric surfaces, the design degree of freedom of the aspheric lens 2 can be appropriately improved to further facilitate the correction of the wavefront aberration.

In one embodiment, the image-side surface of the aspheric lens 2 is provided with a diffraction surface to facilitate the correction of the wavefront aberration.

In one embodiment, the far-infrared optical system with the wide angle satisfies the condition as follows:

$$2. mm < f < 2.1 mm$$

Wherein, f is an effective focal length of the far-infrared optical system with the wide angle.

In one embodiment, the effective focal length of the far-infrared optical system is controlled between 2.0 mm and 2.1 mm to satisfy the requirements of short focal length at the far-infrared waveband, thus satisfying the requirements of a larger field of view of the far-infrared optical system at far-infrared waveband.

In one embodiment, the far-infrared optical system satisfies the condition as follows:

$$0. 825 < \frac{{D}_{m}}{{L}_{m}} < 1$$

Wherein, Dₘ is a maximum effective radius of the far-infrared optical system with the wide angle, L_{M} is a coaxial distance between the object-side surface of the metalens and the image-side surface of the aspheric lens.

Specifically, a center of the object-side surface of the metalens 1 refers to an intersection point between the object-side surface of the metalens 1 and the optical axis of the far-infrared optical system with the wide angle provided by the present application. Similarly, the center of the aspheric lens 2 refers to an intersection point between the image-side surface of the metalens 1 and the optical axis of the far-infrared optical system with the wide angle provided by the present application. The coaxial distance Lₘ between the center of the object-side surface of the metalens 1 and the center of the image-side surface of the metalens 1.

In one embodiment, the highest value of

$$\frac{{D}_{m}}{{L}_{m}}$$

is configured to be 1, which is beneficial to reduce the aperture of the far-infrared optical system with a wide angle, so as to have the advantage of a small aperture; the lowest value of

$$\frac{{D}_{m}}{{L}_{m}}$$

is configured to be 0.825, which is beneficial to reduce the aperture of the far-infrared optical system with a wide angle, so as to have enough relative illumination.

In one embodiment, the far-infrared optical system with a wide angle satisfies the condition as follows:

$$2.25 < \frac{{D}_{2 m}}{{D}_{1 m}}$$

wherein D₁ₘ is an effective diameter of the metalens, D₂ₘ is a maximum diameter of the aspheric surface.

In the present embodiment,

$$\frac{{D}_{2 m}}{{D}_{1 m}}$$

is configured to be greater than 2.25, which is beneficial to compact the whole volume of the far-infrared optical system with a wide angle, and to reduce the TTL of the far-infrared optical system with a wide angle.

Preferably, the far-infrared optical system with a wide angle satisfies the condition as follows:

$$2.25 < \frac{{D}_{2 m}}{{D}_{1 m}} < 3.00$$

In one embodiment, the far-infrared optical system satisfies the condition as follows:

$$1.1 < \frac{\vert {SG}_{2 m} \vert}{\vert {SG}_{1 m} \vert} < 1.35$$

wherein SG₁ₘ is a sagittal maximum height of the object-side surface of the aspheric lens; SG₂ₘ is a sagittal maximum height of the image-side surface of the aspheric lens.

In one embodiment,

$$\frac{\vert {SG}_{2 m} \vert}{\vert {SG}_{1 m} \vert}$$

is controlled between 1.10 and 1.35, which can ensure the aspheric lens 2 has good manufacturing ability and ease of processing, and at the same time the far-infrared optical system with the wide angle has enough relative illumination.

In one embodiment, the far-infrared optical system with the wide angle further includes a window glass 4. The window glass 4 is set between the aspheric lens 2 and the image plane 3. And the window glass 4 is used to protect the image sensor on the image plane 3.

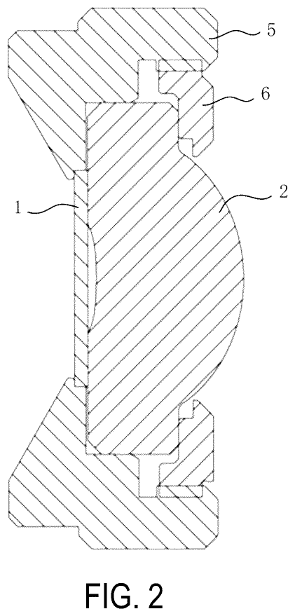

A far-infrared optical camera with a wide angle is provided, and FIG. 2 shows a structural diagram of the far-infrared optical camera with the wide angle of the present application. As shown in FIG. 2, the far-infrared optical camera with the wide angle includes a lens barrel 5 and a far-infrared optical system with a wide angle.

An inner wall of the lens barrel includes two stepped structures: a first-stepped structure and a second-stepped structure. The metalens 1 is set on a platform of the first-stepped structure; and the aspheric lens 2 contacts a platform of the second-stepped structure. Therefore, both the metalens 1 and the aspheric lens 2 are fixed to the inner wall of the lens barrel 5.

In one embodiment, the far-infrared optical camera with the wide angle the object-side surface of the metalens contacts the platform of the first-stepped structure, and the object-side surface of the aspheric lens contacts the platform of the second-stepped structure.

The far-infrared optical camera with the wide angle further includes a pressing ring 6; the pressing ring 6 contacts the image-side surface of the aspheric lens 2. Preferably, the pressing ring 6 contacts the inner wall of the lens barrel 5.

Therefore, in the present application, when the metalens 1 and the aspheric lens 2 are set on the inner wall of the lens barrel. The metalens 1 may be pushed from the image side to the object side, until the object-side surface of the metalens 1 contacts the platform of the first-stepped structure. Then the aspheric lens 2 may be pushed from the image side to the object side, until the object-side surface of the aspheric lens 2 contacts the platform of the second-stepped structure. Finally, the pressing ring 6 may be pushed from the image side to the object side, until the pressing ring 6 contacts the object-side surface of the aspheric lens 2. In this way, the far-infrared optical camera with the wide angle can be packaged efficiently.

TABLE 1
Target requirements for various system parameters of
the far-infrared optical system with the wide angle

| System parameters | Data | |
|---|---|---|
| TTL (total track length) | ≤7.1 | mm |
| Field of view(2ω) | ≥117° | |
| F number | 1.0 | |
| Relative Illumination (RI) | ≥0.78 | |
| Working waveband | 8~12 | μm |

Table 1 shows the target requirements for various system parameters of the far-infrared optical system with the wide angle to be provided.

Specifically, in one embodiment, the target far-infrared optical system with the wide angle to be provided works at the far-infrared waveband of 8˜12 μm; the target total track length is less than 7.1 mm; the target full field of view is greater than or equal to 117°; and the target F number is equal to 1. The target relative illumination is greater than or equal to 0.78.

Moreover, in the present embodiment, for the imaging quality, when the far-infrared optical system with the wide angle is required to cooperate with an imaging detector of 256 pixels*192 pixels and an image element size of 12 m, a value of MTF at a cut-off frequency within 0.9 field of view is greater than or equal to 0.28. MTF is a Modulation Transfer Function, which is an important indicator used to describe the imaging quality of the optical system. The closer the MTF value is to the diffraction limit, the better the imaging quality, and the smaller the fluctuation value of the MTF value, the more stable the imaging quality.

With the target requirements shown in Table 1, the present application provides four embodiments of four far-infrared optical systems with the wide angle that meet the target requirements shown in Table 1 and the corresponding optical cameras working at the far-infrared waveband. Next, the four far-infrared optical systems with the wide angle provided in this application and the corresponding far-infrared optical cameras with the wide angle are described in detail.

### Embodiment 1

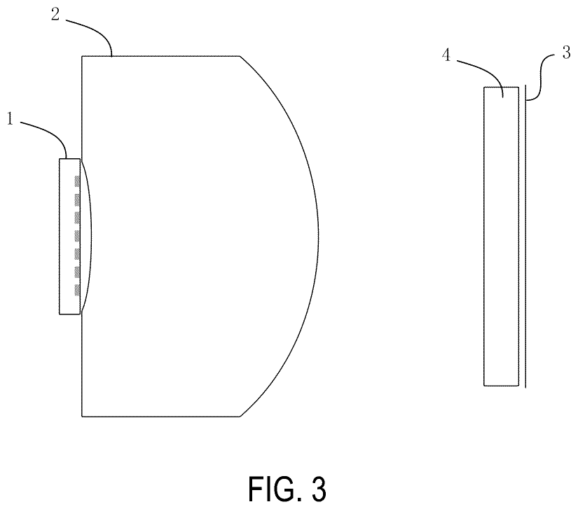

FIG. 3 shows an optical architecture diagram of the far-infrared optical system with the wide angle provided by one embodiment of the present application. As shown in FIG. 3, a far-infrared optical system with the wide angle in the present application, the far-infrared optical system with the wide angle includes a metalens 1, an aspheric lens 2, and a window glass in order from an object side to an image side. The nanostructures may be set on the image-side surface of the metalens 1; the aperture slot is a ring structure that is set on the image-side surface of the metalens 1. The image sensor 3 is set on the image plane.

TABLE 2
Various system parameters of the far-infrared optical
system with the wide angle provided in Embodiment 1

| System parameters | Data | |
|---|---|---|
| TTL (total track length) | 6.74 | mm |
| Field of view(2ω) | 118° | |
| F number | 1 | |
| Effective focal length | 2.08 | mm |
| Working waveband | 8~12 | μm |

As shown in Table 2, the far-infrared optical system with the wide angle provided by the present application works at a target waveband of 8˜12 μm. The total track length is 6.74 mm, which is less than the highest value of target TTL of 7.1 mm, thus satisfying the requirements of miniaturization of the far-infrared optical system with the wide angle. F number is 1, and F number satisfies the target F number, which satisfies the requirements of light intake for the optical system.

From an object side to an image side, each surface of the optical system at the far-infrared waveband provided by the far-infrared optical system with the wide angle is numbered. After summarizing the parameters of each surface, Table 3 is shown below.

TABLE 3
Parameters of the various surfaces in the far-infrared optical
camera with the wide angle provided in Embodiment 1

| Numbered | | Curvature | | |
|---|---|---|---|---|
| surface | Type of surface | radius | Thickness | Material |
| 1 | Spherical surface | Infinite | 0.300 mm | Silicon |
| 2 | Structural surface | Infinite | 0.190 mm | — |
| | (Aperture slot) | | | |
| 3 | Even-order aspheric | −7.520 mm | 3.280 mm | Sulfur glass |
| | surface | | | |
| 4 | Even-order aspheric | −3.750 mm | 2.380 mm | — |
| | surface | | | |
| 5 | Spherical surface | Infinite | 0.500 mm | Silicon |
| 6 | Spherical surface | Infinite | 0.100 mm | — |
| 7 | Image plane | Infinite | — | — |

The surface 1 is an object-side surface of the metalens 1. The surface 2 is an image-side surface of a metalens 1, and the nanostructures are set on the surface 4 in the present application, that is, the surface 2 is recorded as a structural surface (metalens). And the aperture slot is a ring structure that is set on the image-side surface of the metalens 1. That is, the aperture slot is co-planar with the image-side surface of the metalens 1, therefore the surface 2 is recorded as an aperture slot. The surface 3 is the object-side surface of the aspheric lens 3. The surface 4 is an image-side surface of the aspheric surface 2. The surface 5 is an object-side surface of the window glass 4. The surface 6 is an image-side surface of the window glass 4. The surface 7 is an image plane 7.

It can be seen from Table. 3 that the surface 1 is a spherical surface with an infinite curvature radius (that is, a plane), and the distance between the surface 1 and the surface 2 is 0.30 mm, and the filler material filled between the surface 1 and the surface 2 is silicon. The surface 2 is a plane, and the distance between the surface 2 and the surface 3 is 0.19 mm. There is air filled between the surface 2 and surface 3. The surface 3 is the even-order aspheric surface with the curvature radius of −7.52 mm. The distance between the surface 3 and surface 4 is 3.28 mm, and the filler material filled between the surface 3 and surface 4 is the sulfur glass. The surface 4 is an even-order aspheric surface with the curvature radius of −3.75 mm, and the distance between the surface 4 and surface 5 is 2.38 mm. There is air filled between the surface 4 and surface 5. The surface 5 is a plane, and the distance between the surface 5 and the surface 6 is 0.50 mm. The filled material filled between the surface 5 and surface 6 is silicon. The surface 6 is a plane, and the distance between the surface 6 and surface 7 is 0.10 mm. There is air filled between the surface 6 and surface 7. The surface 7 is a plane.

After summarizing the parameters of each aspherical surface in the far-infrared optical system with the wide angle provided in this embodiment, Table 4 as shown below is obtained.

TABLE 4
Parameters of each even-order aspheric surface in the far-infrared
optical system with the wide angle provided in Embodiment 1

| Numbered | | | | | |
|---|---|---|---|---|---|
| surface | k | A | B | C | D |
| 3 | −5.920E+01 | −8.965E−02 | 2.546E−01 | −6.313E−01 | 8.118E−01 |
| 4 | 7.032E−01 | −1.400E−04 | 2.695E−04 | 4.210E−04 | −2.628E−04 |

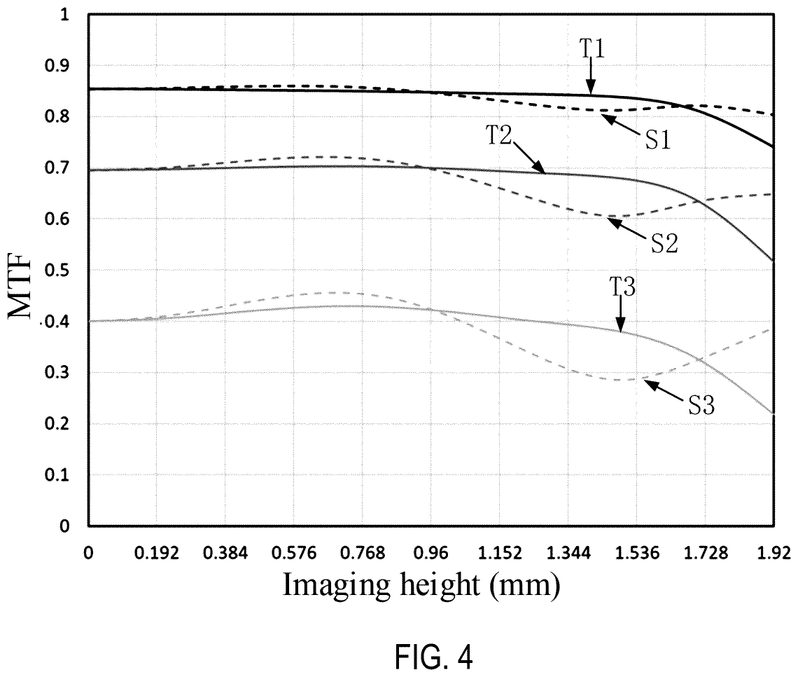

FIG. 4 shows an MTF diagram of the far-infrared optical system with the wide angl provided by Embodiment 1. The horizontal axis of FIG. 4 represents the FOV measuring in the imaging height, and the unit of FOV is mm; the vertical axis represents the MTF value. In FIG. 4, T represents the curve in the meridional direction, S represents the curve in the sagittal direction; the meridional curve T1 and the sagittal curve S1 correspond to the spatial frequency 101 p/mm (line pair/mm), and the meridional curve T2 and the sagittal curve S2 correspond to the cut-off frequency 211 p/mm, and the meridional curve T2 and the sagittal curve S2 correspond to the cut-off frequency 421 p/mm.

As can be seen from FIG. 4, the MTF value at the cut-off frequency of 421 p/mm in the range of 0.9 fields of view (that is, within the range of imaging height of 0˜1.728 mm) is greater than the lowest value of a target MTF of 0.28, which can satisfy the good imaging quality for the optical system.

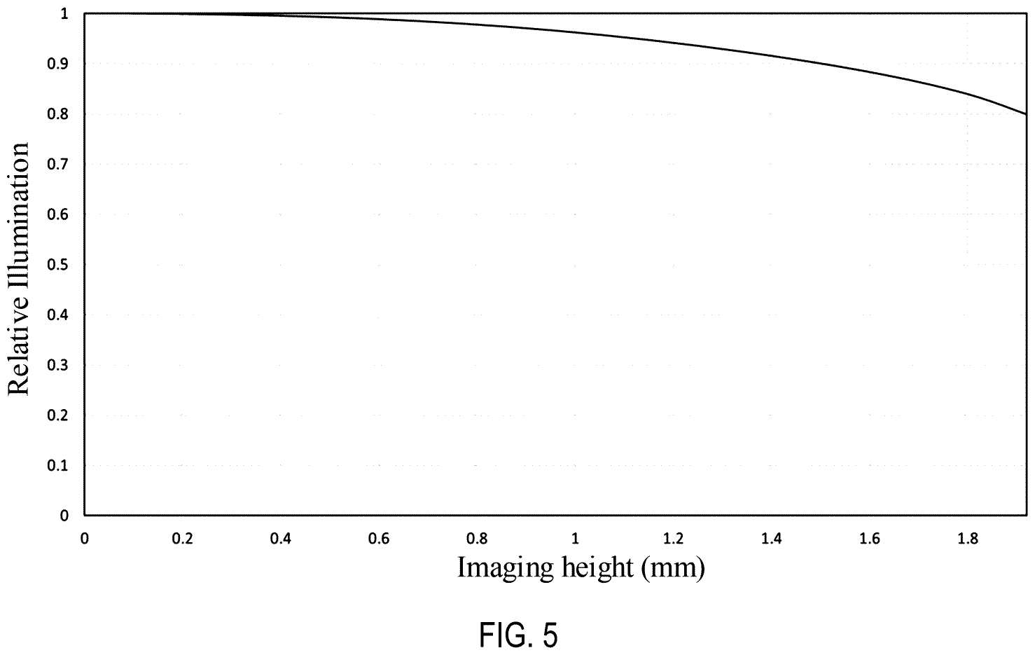

FIG. 5 shows a relative illumination diagram of the far-infrared optical system with the wide angle. The horizontal axis of FIG. 5 represents FOV measuring as the imaging height, and the unit of FOV is mm; the vertical axis represents the relative illumination.

It can be seen in FIG. 5 that the relative illumination at full FOV is greater than 0.8 all the same, and is greater than the lowest value of target relative illumination of 0.78, which satisfies the requirements of high relative illumination.

### Embodiment 2

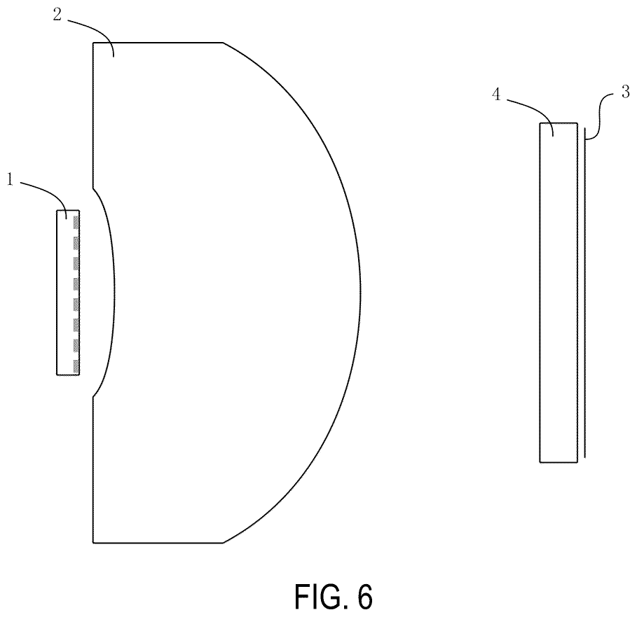

FIG. 6 shows an optical architecture diagram of the far-infrared optical system with the wide angle provided by embodiment 2 of the present application. As shown in FIG. 6, a far-infrared optical system with the wide angle in the present application, the far-infrared optical system with the wide angle includes a metalens 1, an aspheric lens 2, and a window glass 4 in order from an object side to an image side. The nanostructures may be set on the image-side surface of the metalens 1; the aperture slot is a ring structure that is set on the image-side surface of the metalens 1. The image sensor 3 is set on the image plane.

TABLE 5
Various system parameters of the far-infrared optical
system with the wide angle provided in Embodiment 2

| System parameters | Data | |
|---|---|---|
| TTL (total track length) | 7.04 | mm |
| Field of view(2ω) | 120° | |
| F number | 1 | |
| Effective focal length | 2.04 | mm |
| Working waveband | 8~12 | μm |

As shown in Table 5, the far-infrared optical system with the wide angle provided by the present application works at a target waveband of 8˜12 μm. The total track length is 7.04 mm, which is less than the highest value of target TTL of 7.1 mm, thus satisfying the requirements of miniaturization of the far-infrared optical system with the wide angle. And the field of view is 120°, which is greater than the lowest value of a target FOV of 117°, thus satisfying the requirements of a larger FOV for the far-infrared optical system. F number is 1, and F number satisfies the target F number, which satisfies the requirements of light intake for the optical system.

From an object side to an image side, each surface of the optical system at the far-infrared waveband provided by the far-infrared optical system with the wide angle is numbered. After summarizing the parameters of each surface, Table 6 is shown below.

TABLE 6
Parameters of the various surfaces in the far-infrared optical
camera with the wide angle provided in Embodiment 2

| Numbered | | Curvature | | |
|---|---|---|---|---|
| surface | Type of surface | radius | Thickness | Material |
| 1 | Spherical surface | Infinite | 0.300 mm | Silicon |
| 2 | Structural surface | Infinite | 0.470 mm | — |
| | (Aperture slot) | | | |
| 3 | Even-order aspheric | −7.520 mm | 3.280 mm | Germanium |
| | surface | | | |
| 4 | Even-order aspheric | −3.750 mm | 2.393 mm | — |
| | surface | | | |
| 5 | Spherical surface | Infinite | 0.500 mm | Silicon |
| 6 | Spherical surface | Infinite | 0.100 mm | — |
| 7 | Image plane | Infinite | — | — |

Similar to the descriptions given in Table 3, Table 6 will not be repeated here.

After summarizing the parameters of each aspherical surface in the far-infrared optical system with the wide angle provided in this embodiment, Table 7 as shown below is obtained.

TABLE 7
Parameters of each even-order aspheric surface in the far-infrared
optical system with the wide angle provided in Embodiment 2

| Numbered | | | | | |
|---|---|---|---|---|---|
| surface | k | A | B | C | D |
| 3 | 1.277E+01 | 1.437E−03 | −1.335E−02 | −5.173E−03 | 1.730E−02 |
| 4 | −3.868E−01 | −1.184E−03 | −2.084E−04 | −8.531E−06 | 9.448E−06 |

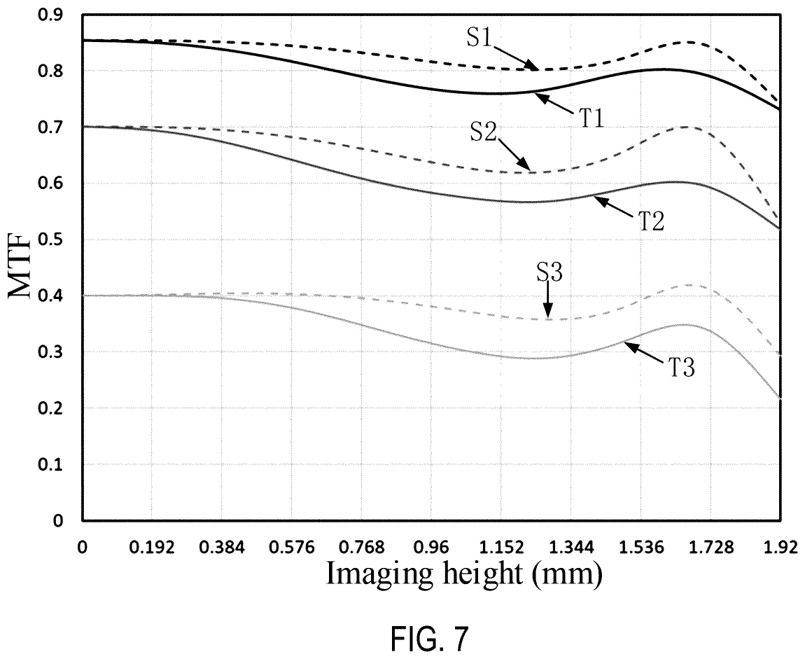

FIG. 7 shows an MTF diagram of the far-infrared optical system with the wide angle provided by Embodiment 2. As for the description of the meaning of the horizontal and vertical axis of FIG. 4 and the meaning of each curve, the meaning of the horizontal and vertical axis of each curve will not be repeated here.

As can be seen from FIG. 7, the MTF value at the cut-off frequency of 421p/mm in the range of 0.9 fields of view (that is, within the range of imaging height of 0˜1.728 mm) is greater than the lowest value of the target MTF of 0.28, which can satisfy the good imaging quality for the optical system.

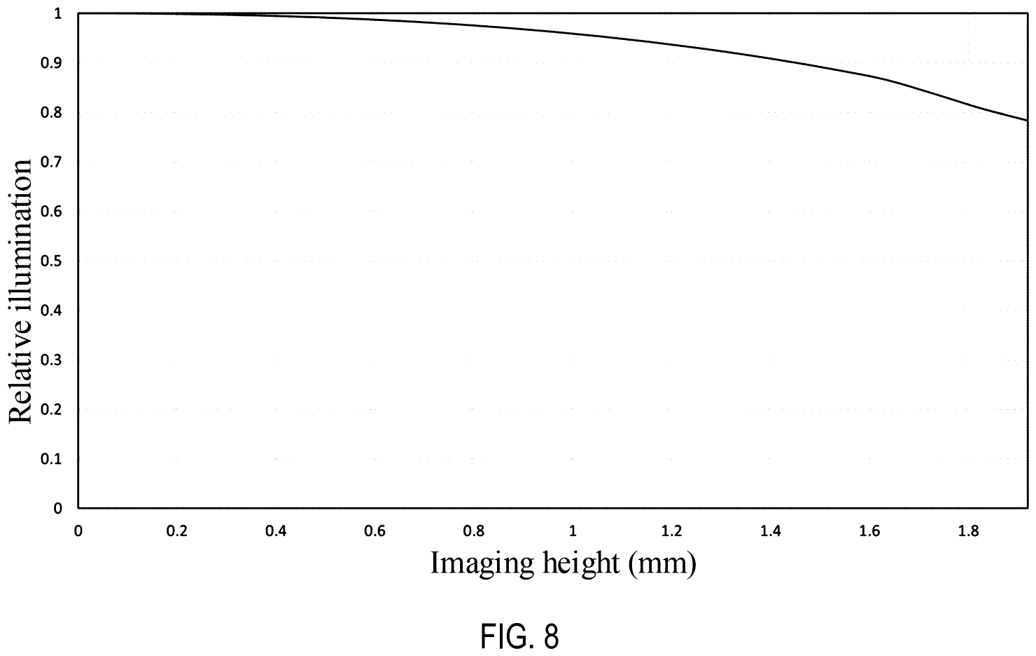

FIG. 8 shows a relative illumination diagram of the far-infrared optical system with the wide angle. The horizontal axis of FIG. 8 represents FOV measuring as the imaging height, and the unit of FOV is mm; the vertical axis represents the relative illumination.

It can be seen in FIG. 8 that the relative illumination is greater than or equal to the lowest value of target relative illumination of 0.78, which satisfies the requirements of high relative illumination.

### Embodiment 3

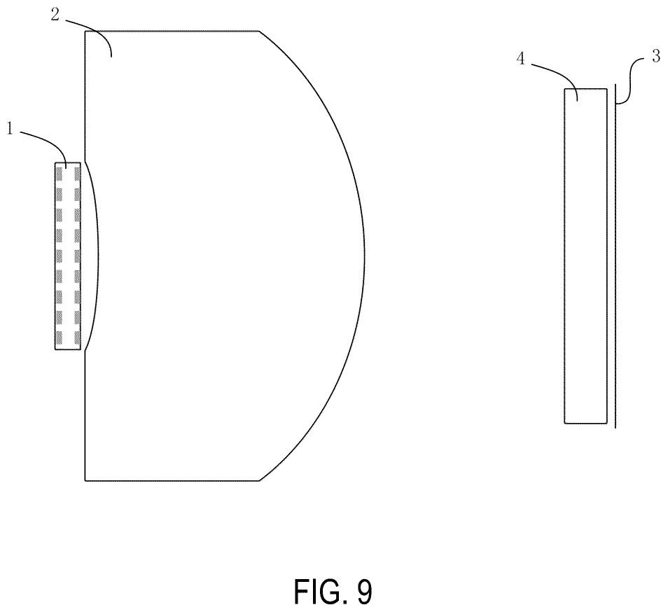

FIG. 9 shows an optical architecture diagram of the far-infrared optical system with the wide angle provided by embodiment 3 of the present application. As shown in FIG. 9, a far-infrared optical system with the wide angle in the present application, the far-infrared optical system with the wide angle includes a metalens 1, an aspheric lens 2, and a window glass 4 in order from an object side to an image side. The nanostructures may be set on the image-side surface of the metalens 1; the aperture slot is a ring structure that is set on the image-side surface of the metalens 1. The image sensor 3 is set on the image plane.

TABLE 8
Various system parameters of the far-infrared optical
system with the wide angle provided in Embodiment 3

| System parameters | Data | |
|---|---|---|
| TTL (total track length) | 6.61 | mm |
| Field of view(2ω) | 118° | |
| F number | 1 | |
| Effective focal length | 2.04 | mm |
| Working waveband | 8~12 | μm |

As shown in Table 8, the far-infrared optical system with the wide angle provided by the present application works at a target waveband of 8˜12 μm. The total track length is 6.61 mm, which is less than the highest value of target TTL of 7.1 mm, thus satisfying the requirements of miniaturization of the far-infrared optical system with the wide angle. And the field of view is 118°, which is greater than the lowest value of the target FOV of 117°, thus satisfying the requirements of a larger FOV for the far-infrared optical system. F number is 1, and F number satisfies the target F number, which satisfies the requirements of light intake for the optical system.

From an object side to an image side, each surface of the optical system at the far-infrared waveband provided by the far-infrared optical system with the wide angle is numbered. After summarizing the parameters of each surface, Table 9 is shown below.

TABLE 9
Parameters of the various surfaces in the far-infrared optical
camera with the wide angle provided in Embodiment 3

| Numbered | | Curvature | | |
|---|---|---|---|---|
| surface | Type of surface | radius | Thickness | Material |
| 1 | Spherical surface | Infinite | 0.300 mm | Silicon |
| 2 | Structural surface | Infinite | 0.211 mm | — |
| | (Aperture slot) | | | |
| 3 | Even-order aspheric | −7.063 mm | 3.139 mm | Sulfur glass |
| | surface | | | |
| 4 | Even-order aspheric | −3.680 mm | 2.357 mm | — |
| | surface | | | |
| 5 | Spherical surface | Infinite | 0.500 mm | Silicon |
| 6 | Spherical surface | Infinite | 0.100 mm | — |
| 7 | Image plane | Infinite | — | — |

Similar to the descriptions given in Table 3, Table 9 will not be repeated here.

After summarizing the coefficient of the even aspherical surface in the wide-angle far-infrared optical system provided in this embodiment, Table 10 as shown below is obtained.

TABLE 10
Coefficients of even-order aspheric surfaces in the far-infrared
optical system with the wide angle provided in Embodiment 3

| Numbered | | | | | |
|---|---|---|---|---|---|
| surface | k | A | B | C | D |
| 3 | −4.844E+00 | −9.766E−02 | 3.176E−01 | −7.137E−01 | 8.378E−01 |
| 4 | 7.144E−01 | −7.014E−04 | 6.208E−04 | 3.263E−04 | −2.517E−04 |

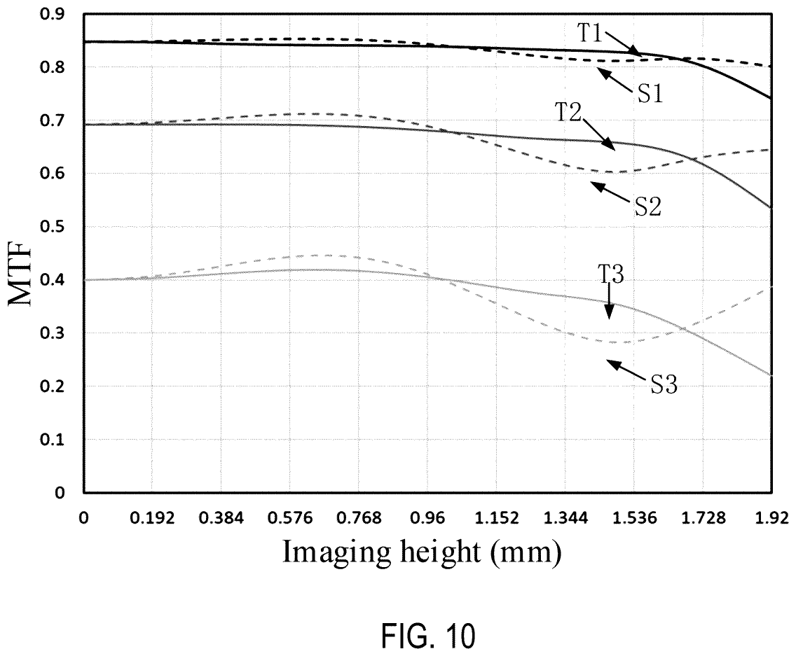

FIG. 10 shows an MTF diagram of the far-infrared optical system with the wide angle provided by Embodiment 3. As for the description of the meaning of the horizontal and vertica axis of FIG. 4 and the meaning of each curve, the meaning of the horizontal and vertical axis of each curve will not be repeated here.

As can be seen from FIG. 10, the MTF value at the cut-off frequency of 421p/mm in the range of 0.9 fields of view (that is, within the range of imaging height of 0˜1.728 mm) is greater than the lowest value of the target MTF of 0.28, which can satisfy the good imaging quality for the optical system.

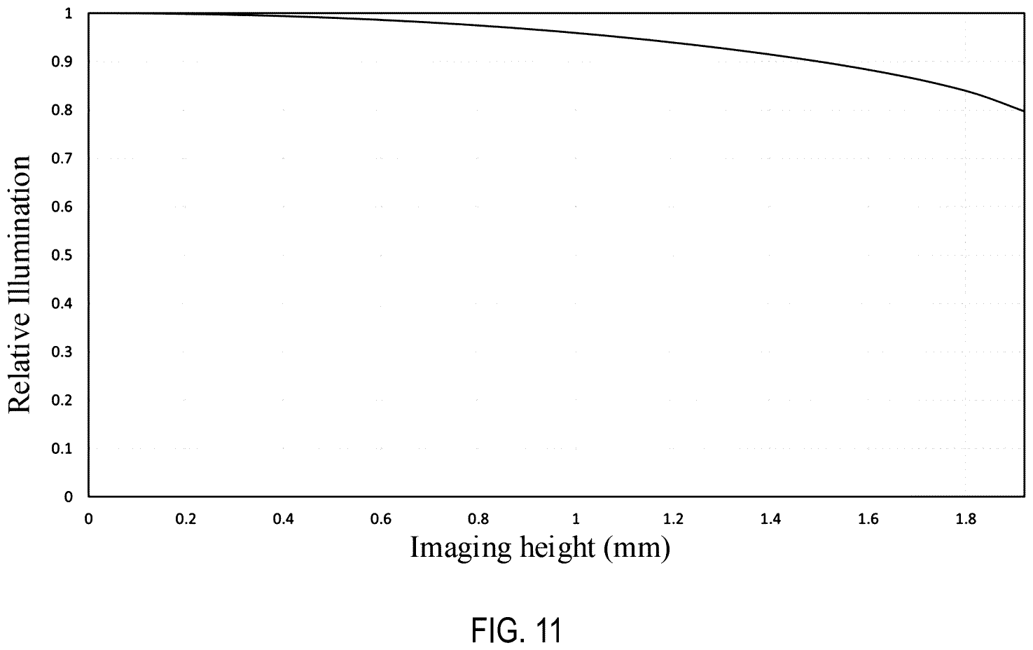

FIG. 11 shows a relative illumination diagram of the far-infrared optical system with the wide angle. The horizontal axis of FIG. 11 represents FOV measuring as the imaging height, and the unit of FOV is mm; the vertical axis represents the relative illumination.

It can be seen in FIG. 8 that the relative illumination is greater than 0.8 all the time, which is greater than the lowest value of target relative illumination of 0.78, which satisfies the requirements of high relative illumination.

### Embodiment 4

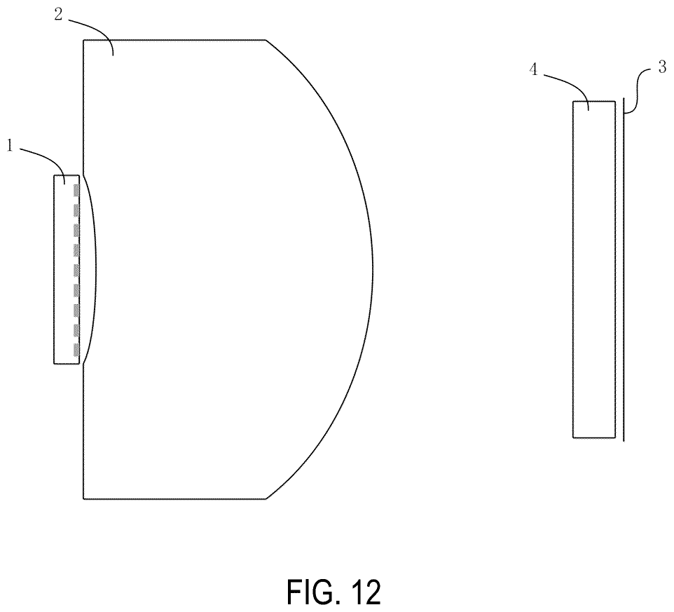

FIG. 12 shows an optical architecture diagram of the far-infrared optical system with the wide angle provided by embodiment 4 of the present application. As shown in FIG. 12, a far-infrared optical system with the wide angle in the present application, the far-infrared optical system with the wide angle includes a metalens 1, an aspheric lens 2, and a window glass 4 in order from an object side to an image side. The nanostructures may be set on the image-side surface of the metalens 1; the aperture slot is a ring structure that is set on the image-side surface of the metalens 1. The image sensor 3 is set on the image plane.

TABLE 11
Various system parameters of the far-infrared optical
system with the wide angle provided in Embodiment 4

| System parameters | Data | |
|---|---|---|
| TTL (total track length) | 6.73 | mm |
| Field of view(2ω) | 117° | |
| F number | 1 | |
| Effective focal length | 2.06 | mm |
| Working waveband | 8~12 | μm |

As shown in Table 11, the far-infrared optical system with the wide angle provided by the present application works at a target waveband of 8˜12 μm. The total track length is 6.73 mm, which is less than the highest value of target TTL of 7.1 mm, thus satisfying the requirements of miniaturization of the far-infrared optical system with the wide angle. And the filed of view is greater than lowest value of target FOV of 117°, which satisfies the requirements of larger FOV for the far-infrared optical system. F number is 1, and F number satisfies the target F number, which satisfies the requirements of light intake for the optical system.

From an object side to an image side, each surface of the optical system at the far-infrared waveband provided by the far-infrared optical system with the wide angle is numbered. After summarizing the parameters of each surface, Table 12 is shown below.

TABLE 12
Parameters of the various surfaces in the far-infrared optical
camera with the wide angle provided in Embodiment 4

| Numbered | | Curvature | | |
|---|---|---|---|---|
| surface | Type of surface | radius | Thickness | Material |
| 1 | Spherical surface | Infinite | 0.300 mm | Silicon |
| 2 | Structural surface | Infinite | 0.197 mm | — |
| | (Aperture slot) | | | |
| 3 | Even-order aspheric | −7.363 mm | 3.271 mm | Sulfur glass |
| | surface | | | |
| 4 | Even-order aspheric | −3.745 mm | 2.367 mm | — |
| | surface | | | |
| 5 | Spherical surface | Infinite | 0.500 mm | Silicon |
| 6 | Spherical surface | Infinite | 0.100 mm | — |
| 7 | Image plane | Infinite | — | — |

Similar to the descriptions given in Table 3, Table 12 will not be repeated here.

After summarizing the coefficient of the even aspherical surface in the wide-angle far-infrared optical system provided in this embodiment, Table 13 as shown below is obtained.

TABLE 13
Coefficients of even-order aspheric surfaces in the far-infrared
optical system with the wide angle provided in Embodiment 4

| Numbered | | | | | |
|---|---|---|---|---|---|
| surface | k | A | B | C | D |
| 3 | −1.181E+01 | −9.492E−02 | 3.102E−01 | −7.015E−01 | 8.315E−01 |
| 4 | 7.049E−01 | −4.185E−01 | 4.609E−02 | −3.536E−03 | −1.429E−04 |

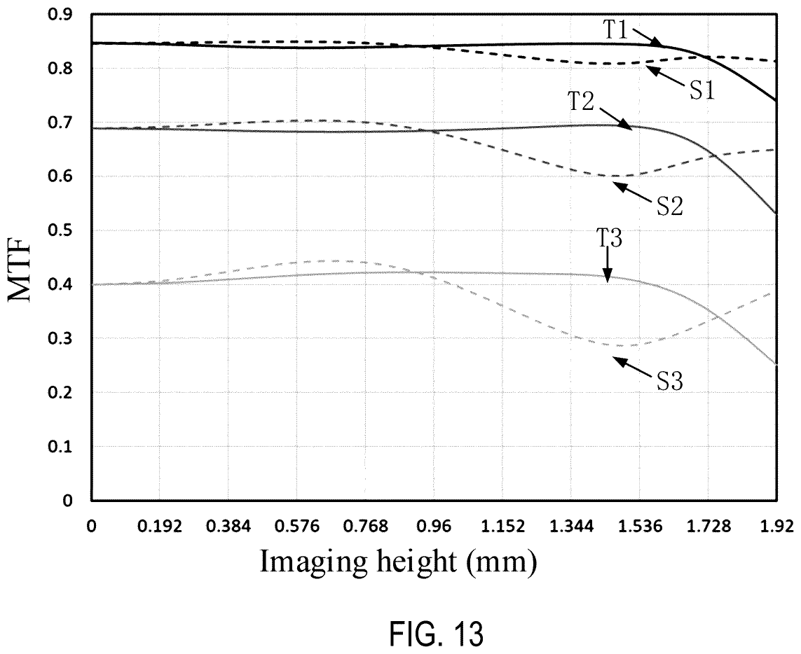

FIG. 13 shows an MTF diagram of the far-infrared optical system with the wide angle provided by Embodiment 4. As for the description of the meaning of the horizontal and vertical axis of FIG. 4 and the meaning of each curve, the meaning of the horizontal and vertical axis of each curve will not be repeated here.

As can be seen from FIG. 13, the MTF value at the cut-off frequency of 421p/mm in the range of 0.9 fields of view (that is, within the range of imaging height of 0˜1.728 mm) is greater than the lowest value of the target MTF of 0.28, which can satisfy the good imaging quality for the optical system.

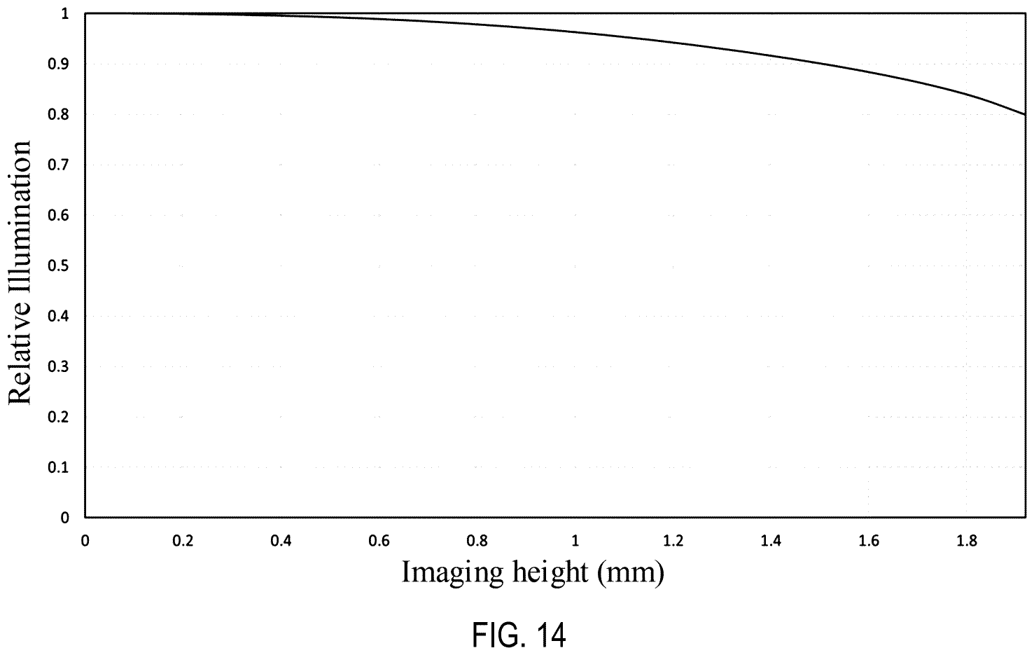

FIG. 14 shows a relative illumination diagram of the far-infrared optical system with the wide angle. The horizontal axis of FIG. 14 represents FOV measuring as the imaging height, and the unit of FOV is mm; the vertical axis represents the relative illumination.

It can be seen in FIG. 14 that the relative illumination is greater than 0.8 all the time, which is greater than the lowest value of target relative illumination of 0.78, which satisfies the requirements of high relative illumination.

After summarizing the various parameters of each aspherical surface in the far-infrared optical system with the wide angle provided by the above four embodiments, Table 14 is shown below. The displays in Table 14 are mainly used to explain the conditions met by the far-infrared optical system with the wide angle provided in this application, and are experimentally verified and supported.

TABLE 14
The various parameters of the far-infrared optical system with the
wide angle provided by the respective embodiments

| Condition | Embodiment 1 | | Embodiment 2 | | Embodiment 3 | | Embodiment 4 | |
|---|---|---|---|---|---|---|---|---|
| f | 2.08 | mm | 2.04 | mm | 2.04 | mm | 2.06 | mm |
| Dₘ | 5.07 | mm | 6.36 | mm | 5.14 | mm | 5.26 | mm |
| Lₘ | 6.119 | mm | 6.443 | mm | 6.007 | mm | 6.135 | mm |
| D₁ₘ | 2.236 | mm | 2.191 | mm | 2.194 | mm | 2.217 | mm |
| D₂ₘ | 5.07 | mm | 6.36 | mm | 5.14 | mm | 5.26 | mm |
| \|SG₁ₘ\| | 0.108 | mm | 0.099 | mm | 0.110 | mm | 0.105 | mm |
| \|SG₂ₘ\| | 0.138 | mm | 0.114 | mm | 0.140 | mm | 0.138 | mm |
| $\frac{{D}_{m}}{{L}_{m}}$ | 0.829 | | 0.987 | | 0.856 | | 0.857 | |
| $\frac{{D}_{2 m}}{{L}_{1 m}}$ | 2.267 | | 2.903 | | 2.343 | | 2.373 | |
| $\frac{\vert {SG}_{2 m} \vert}{\vert {SG}_{1 m} \vert}$ | 1.278 | | 1.152 | | 1.273 | | 1.314 | |

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. A far-infrared optical system with a wide angle, comprising a metalens, an aperture slot, and an aspheric lens in order from an object side to an image side;
wherein, each of the metalens and the aspheric lens has a positive focal power;
each of the metalens and the aspheric lens comprises an object-side surface facing towards the object side and an image-side surface facing towards the image side;
the aperture slot is a ring structure set on the image-side surface of the metalens;
the metalens comprises a plurality of nanostructures, and a projection of the plurality of nanostructures in an effective region of the image-side surface of the metalens is located inside a ring region of the aperture slot.

2. The far-infrared optical system with the wide angle according to claim 1, wherein the plurality of nanostructures are set on the image-side surface of the metalens.

3. The far-infrared optical system with the wide angle according to claim 1, wherein the plurality of nanostructures are set on both the image-side surface of the metalens and the object-side surface of the metalens.

4. The far-infrared optical system with the wide angle according to claim 1, wherein both the image-side surface and the object-side surface of the aspheric lens are even-order surfaces.

5. The far-infrared optical system with the wide angle according to claim 4, wherein a back focal length of the far-infrared optical system is greater than or equal to 2.96 mm, and is less than or equal to 3 mm.

6. The far-infrared optical system with the wide angle according to claim 1, wherein the far-infrared optical system with the wide angle satisfies a condition as follows:
$$2. mm < f < 2.1 mm$$
wherein f is an effective focal length of the far-infrared optical system with the wide angle.

7. The far-infrared optical system with the wide angle according to claim 1, wherein the far-infrared optical system with the wide angle satisfies a condition as follows:
$$0. 825 < \frac{{D}_{m}}{{L}_{m}} < 1$$
wherein Dₘ is a maximum effective radius of the far-infrared optical system with the wide angle, and L_{M} is a coaxial distance between the object-side surface of the metalens and the image-side surface of the aspheric lens.

8. The far-infrared optical system with the wide angle according to claim 1, wherein the far-infrared optical system with the wide angle satisfies a condition as follows:
$$2.25 < \frac{{D}_{2 m}}{{D}_{1 m}}$$
wherein D₁ₘ is an effective diameter of the metalens, and D₂ₘ is a maximum diameter of the aspheric surface.

9. The far-infrared optical system with the wide angle according to claim 8, wherein far-infrared optical system with the wide angle satisfies a condition as follows:
$$2.25 < \frac{{D}_{2 m}}{{D}_{1 m}} < 3.00 .$$

10. The far-infrared optical system with the wide angle according to claim 1, wherein the far-infrared optical system with the wide angle satisfies a condition as follows:
$$1. 10 < \frac{\vert {SG}_{2 m} \vert}{\vert {SG}_{1 m} \vert} < 1.35$$
wherein SG₁ₘ is a sagittal maximum height of the object-side surface of the aspheric lens; and SG₂ₘ is a sagittal maximum height of the image-side surface of the aspheric lens.

11. The far-infrared optical system with the wide angle according to claim 1, wherein a thickness of the aspheric lens is greater than or equal to 3.139 mm, and is less than or equal to 3.28 mm.

12. The far-infrared optical system with the wide angle according to claim 1, wherein a total track length of the far-infrared optical system with the wide angle is less than or equal to 7.1 mm.

13. The far-infrared optical system with the wide angle according to claim 1, wherein a field of view of the far-infrared optical system with the wide angle is greater than or equal to 117°.

14. The far-infrared optical system with the wide angle according to claim 1, wherein an F number of the far-infrared optical system with the wide angle is 1.

15. The far-infrared optical system with the wide angle according to claim 1, wherein a curvature radius of the object-side surface of the aspheric lens is greater than or equal to −7.52 mm, and is less than or equal to −7.063 mm.

16. The far-infrared optical system with the wide angle according to claim 1, wherein a curvature radius of the image-side surface of the aspheric lens is greater than or equal to −3.745 mm, and is less than or equal to −3.68 mm.

17. A far-infrared optical camera with the wide angle, wherein the far-infrared optical camera with the wide angle comprises a lens barrel and the far-infrared optical system with the wide angle claimed as claim 1;
wherein an inner wall of the lens barrel is set with a first-stepped structure and a second-stepped structure;
the metalens is set on a platform of the first-stepped structure; and the aspheric lens is set on a platform of the second-stepped structure.

18. The far-infrared optical camera with the wide angle according to claim 17, wherein
the object-side surface of the metalens contacts the platform of the first-stepped structure, and the object-side surface of the aspheric lens contacts the platform of the second-stepped structure.

19. The far-infrared optical camera with the wide angle according to claim 17, wherein the far-infrared optical camera with the wide angle further comprises a pressure ring; the pressing ring contacts the image-side surface of the aspheric lens.

20. The far-infrared optical camera with the wide angle according to claim 19, wherein the pressing ring contacts the inner wall of the lens barrel.
